(19) United States
(12) Patent Application Publication
(10) Pub. No.: US 2008/0107954 A1
(43) Pub. Date: May 8, 2008

(54) Fuel Cell Stack

(75) Inventors: Dong-Uk Lee, Yongin-si (KR); Chi-Seung Lee, Yongsin-si (KR); Chan-Hee Park, Yongin-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd, Suwon-si (KR)

(21) Appl. No.: 11/924,542

(22) Filed: Oct. 25, 2007

(30) Foreign Application Priority Data
Nov. 3, 2006 (KR) 10-2006-0108237

(51) Int. Cl. H01M 2/14

(52) U.S. Cl. 429/34

(57) ABSTRACT

A fuel cell stack comprises: an electricity generating assembly including electricity generators based on a unit cell; a pair of pressing plates that respectively come in close contact with the outermost surfaces of the electricity generators so as to press the electricity generators; a plurality of connection rods connecting the pressing plates; a fastening member that is screwed to each of the connection rods so as to fasten the pressing plates; and a spacer that is disposed at each of the connection rods between the pressing plates so as to control a fastening pressure exerted by the fastening member.

### CROSS-REFERENCE TO RELATED APPLICATION

This application claims priority to and the benefit of Korean Patent Application No. 10-2006-0108237 filed on Nov. 3, 2006 in the Korean Intellectual Property Office, the entire contents of which is incorporated herein by reference.

### BACKGROUND OF THE INVENTION

1. Technical Field

The present disclosure relates to a fuel cell stack, and more particularly, to a fastening structure for a fuel cell stack.

2. Description of the Related Art

Fuel cells are well-known electrical generation systems that directly convert chemical energy from a reaction between a fuel and an oxidant into electrical energy. Fuel cells can be classified into several types depending on the type of fuel and the components of the fuel cell.

Some embodiments of fuel cells comprise a stack of a plurality of aligned unit cells, referred to herein as a “fuel cell stack”. A fuel and an oxidant are supplied to the unit cells, thereby producing electrical energy. The fuel cell comprises a pair of pressing plates (generally referred to as “end plates”) located at the ends of the stack of the unit cells. The pressing plates are fastened to each other, thereby pressing the unit cells together.

When the fuel cell stack is assembled according to the typical method, a rod is inserted through the stack of unit cells, thereby aligning the unit cells. The pressing plates contact the outermost unit cells interposed therebetween. Further, the pressing plates are fastened to each other by means of fastening members, such as bolts and nuts. The fastening members exert a fastening pressure, thereby pressing the unit cells together.

In this assembly process, the unit cells are compressed with a predetermined pressing range, which depends on a total length of the unit cells and an optimal compression degree of the unit cells. However, it is not easy to control the fastening pressure exerted by the fastening members to within the pressure range due to differences in operator skill or mechanical errors of a torque device.

For this reason, in the past, the unit cells in the stack have been subjected to excessive or insufficient fastening pressures, thereby requiring an additional task checking and correcting the fastening pressure of the fastening members. Therefore, an overall time for manufacturing the stack increases. In particular, when the stack is repaired or mended, it is not easy to properly reassemble the stack.

### SUMMARY OF THE INVENTION

Some embodiments provide a fuel cell stack that has a simple structure in which a fastening pressure exerted by fastening members is controllable, so that a desired fastening pressure exerted by the fastening members, corresponding to a predetermined pressure range for unit cells, can be easily supplied to pressing plates.

According to one aspect, there is provided a fuel cell stack that is constructed as an electricity generating assembly and in which a plurality of electricity generators are consecutively aligned, the fuel cell stack including: a pair of pressing plates that respectively come in close contact with the outermost surfaces of the electricity generators and are fastened with each other to press the electricity generators; and a stopper that is disposed between the pressing plates to control a pressure exerted by the pressing plates.

In the aforementioned aspect, the stopper may include a bar passing through the electricity generators. A plurality of bars may be provided, and the plurality of bars passes through respective edge portions of the electricity generators. In this case, the bar may be fixed to one of the pressing plates, or the bar may be disposed independently from the pressing plates.

In addition, the bar may have a length corresponding to a predetermined pressure range for the electricity generators according to a predetermined pressure exerted by the pressing plates.

In addition, the bar may be made of a conductive metallic material, and an insulation layer is formed on the surface of the bar. Alternatively, the bar may be made of an insulating plastic or a ceramic material.

According to another aspect, there is provided a fuel cell stack including: an electricity generating assembly including electricity generators based on a cell unit; a pair of pressing plates that are respectively in close contact with the outermost surfaces of the electricity generators so as to press the electricity generators; a plurality of connection rods connecting the pressing plates; a fastening member that is screw-bonded to each of the connection rods so as to fasten the pressing plates; and a stopper that is disposed at each of the connection rods between the pressing plates so as to control a fastening pressure exerted by the fastening member.

In the aforementioned aspect, the stopper may have a shape of a pipe having a hollow through which the connection rods are inserted.

In addition, the stopper may be fixed to one of the pressing plates. In this case, each pressing plate may include through-holes through which the connection rods pass, and the stopper may be disposed such that the hollow is connected to each of the through-holes. Alternatively, the stopper may be disposed independently from the pressing plates.

In addition, the stopper may have a length corresponding to a predetermined pressure range for the electricity generating assembly according to a predetermined fastening pressure exerted by the fastening member.

In addition, the stopper may be made of a material selected from the group consisting of a metal, a plastic, and a ceramic.

In addition, a bolt head may be formed at one end of each connection rod, and a screw portion may be formed at the other end of each connection rod. In this case, the fastening member may include a nut that is joined with the screw portion.

In addition, a plurality of stoppers may be provided, and the plurality of connection rods may pass through respective edge portions of the pressing plates.

Some embodiments provide a fuel cell stack for generating electricity, the fuel cell stack comprising: a plurality of aligned electricity generators aligned with a first end and a second end; a first pressing plate contacting the first end of the aligned electricity generators, and a second pressing plate contacting the second end of the aligned electricity generators; fastening members configured and dimensioned to fasten the first and second pressing plates to each other and to compress the plurality of aligned electricity generators therebetween; and a spacer disposed between the pressing plates to control a pressure exerted by the first and second pressing plates.

In some embodiments, the spacer comprises a bar passing through the plurality of electricity generators. Some embodiments comprise a plurality of bars, wherein each of the plurality of bars passes through respective edge portions of the electricity generators. In some embodiments, the bar is secured to one of the first and second pressing plates. In some embodiments, the bar is not secured to either of the first or second pressing plates. In some embodiments, a length of the bar is selected to provide a predetermined pressure range to the electricity generators according to a predetermined pressure exerted by the first and second pressing plates. In some embodiments, the bar comprises a conductive metal and an insulation layer disposed on a surface thereof. In some embodiments, the bar comprises an insulating plastic or ceramic material.

Some embodiments provide a fuel cell stack comprising: an electricity generating assembly comprising unit-cell electricity generators; a pair of pressing plates, one of each disposed on an end of the electricity generating assembly, configured and dimensioned to compress the electricity generators therebetween; a plurality of connection rods extending between the pressing plates; a plurality of fastening members, each secured to an end of a corresponding connection rod, thereby fastening the pressing plates to each other; and a spacer disposed around each of the connection rods and between the pressing plates, dimensioned and configured to control a fastening pressure exerted by each fastening member.

In some embodiments, each spacer comprises a pipe or tube having a hollow portion through which a connection rod is inserted. In some embodiments, the spacer is secured to one of the pressing plates. In some embodiments, each pressing plate comprises a plurality of through-holes through which the connection rods pass, and the hollow portion of each spacer is aligned with one of the through-holes. In some embodiments, the spacer is not secured to either of the pressing plates. In some embodiments, the spacer has a length selected to provide a predetermined pressure range for the electricity generating assembly according to a predetermined fastening pressure exerted by the fastening members. In some embodiments, the spacer comprises at least one of a metal, a plastic, and a ceramic. In some embodiments, a bolt head is formed at a first end of each connection rod, and a threaded portion is formed at a second end of each connection rod. In some embodiments, the fastening member comprises a nut dimensioned and configured to engage a threaded portion of the connection rod. Some embodiments comprise a plurality of spacers, and the plurality of connection rods pass through respective edge portions of the pressing plates.

### BRIEF DESCRIPTION OF THE DRAWINGS

The above and other features and advantages will become more apparent by describing in detail exemplary embodiments thereof with reference to the attached drawings, in which:

FIG. 1 is an exploded perspective view of a fuel cell stack according to a first embodiment of a fuel cell stack;

FIG. 2 is a cross-sectional view of the fuel cell stack shown in FIG. 1;

FIG. 3 is a cross-sectional view schematically illustrating the fuel cell stack shown in FIG. 1 in order to explain a process of assembling the fuel cell stack;

FIG. 4 is a cross-sectional view schematically illustrating a fuel cell stack according to a second embodiment;

FIG. 5 is a cross-sectional view schematically illustrating a fuel cell stack according to a third embodiment;

FIG. 6 is a cross-sectional view schematically illustrating a fuel cell stack according to a fourth embodiment;

FIG. 7 is a cross-sectional view schematically illustrating the fuel cell stack shown in FIG. 6 in order to explain a process of assembling the fuel cell stack; and

FIG. 8 is a cross-sectional view schematically illustrating a fuel cell stack according to a fifth embodiment.

### DETAILED DESCRIPTION OF CERTAIN EMBODIMENTS

With reference to the accompanying drawings, certain embodiments will be described. As those skilled in the art would realize, the described embodiments may be modified in various different ways, all without departing from the spirit or scope of the present disclosure.

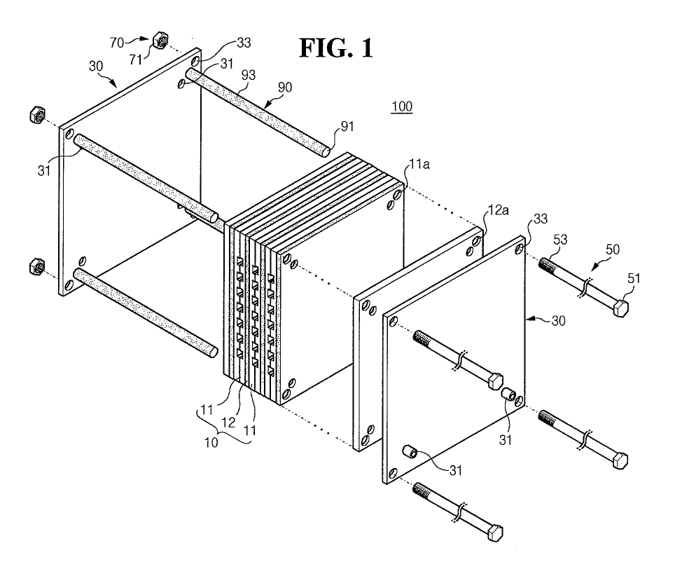

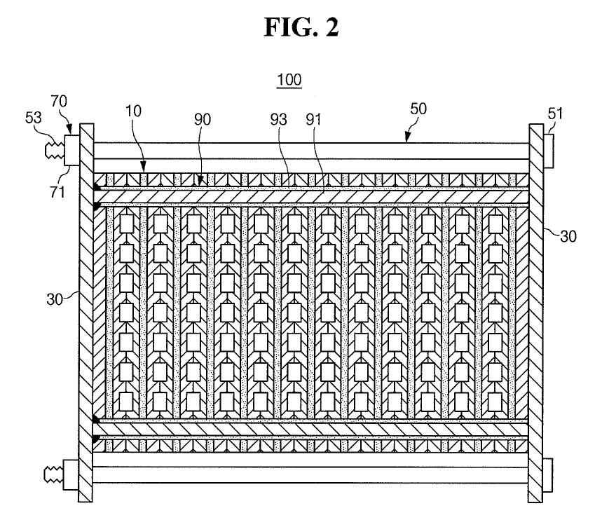

FIG. 1 is an exploded perspective view of a fuel cell stack according to a first embodiment of a fuel cell stack, and FIG. 2 is a cross-sectional view of the stack shown in FIG. 1. Referring to FIG. 1, a fuel cell stack 100 of the first embodiment is an electrical generation system that generates electrical energy through a reaction between a fuel and an oxidant. The fuel may include a liquid alcoholic fuel such as methanol and/or ethanol. Furthermore, the fuel may include a reforming gas that is obtained by reforming a liquid fuel or a gaseous fuel such as methane, ethane, propane, and/or butane. The oxidant may be oxygen gas stored in a separate tank or may be unprocessed air.

In the first embodiment, the fuel cell stack 100 includes a plurality of electricity generators 10, forming an electrical generating assembly; a pair of pressing plates 30 pressing the electricity generators 10 together; a plurality of connection rods 50 connecting the pressing plates 30; and a plurality of fastening members 70 fastening the pressing plates 30 together.

The electricity generators 10 include unit cells that generate electrical energy through an electrochemical reaction between a fuel and an oxidant. Thus, the fuel cell stack 100 of the first embodiment may comprise an electricity generating assembly comprising a plurality of electricity generators 10 consecutively aligned.

Each electricity generator 10 typically includes a membrane-electrode assembly (MEA) 11 and separators 12 contacting each surface of the membrane electrode assembly 11. In the illustrated embodiment, each separator 12 comprises a square conductive plate. A channel (not shown) is formed on a surface of each separator 12 contacting the membrane electrode assembly 11 so as to provide a path for the fuel and/or the oxidant. Alternatively, the channel may be formed on both surfaces of each separator 12.

The membrane electrode assembly 11 comprises an anode electrode on one side and a cathode electrode on the other side, with an electrolyte membrane disposed between the two electrodes. At the anode electrode, the fuel is oxidized to provide electrons and hydrogen ions. The hydrogen ions migrate through the electrolyte membrane to the cathode electrode. At the cathode electrode, the oxidant is reduced by electrons from the anode electrode and reacts with the hydrogen ions, thereby generating water and heat.

The pressing plates 30 contact the outermost electricity generators 10. The pressing plates 30 are coupled together by connection rods 50 and fastening members 70. As a result, the electricity generators 30 are compressed between the generally parallel pressing plates 30, which, as discussed above, are square-shaped metallic plates, each with a predetermined thickness.

Fuel and oxidant are supplied to the respective electricity generators 10 through the pressing plates 30. In use, unreacted fuel and oxidant, as well as reaction products generated therefrom, are contained in the electricity generators 10. A plurality of ports 31 is formed in the pressing plates 30, dimensioned and configured to discharge the unreacted fuel and oxidant, and the reaction products. In addition, through-holes 33 are formed at edge portions of the pressing plates 30, dimensioned and configured to receive the connection rods 50 therethrough.

The connection rods 50 interconnect the pressing plates 30. The connection rods 50 are inserted through the through-holes 33 of a first pressing plate 30, then inserted into the through-holes 33 of the second pressing plate 30. The connection rods 50 are disposed outside the perimeter of the electricity generators 10, parallel to the axis in which the electricity generators 10 are arranged. Each connection rod 50 has a shape of a bolt, in which a first end includes a bolt head 51 and a second end includes a threaded portion 53.

The fastening members 70 fasten the pressing plates 30 and provide a specific pressure to the pressing plates 30. Each fastening member 70 includes a nut 71 that is screwed onto the threaded portion 53 of each connection rod 50.

When assembling a fuel cell stack 100 having the aforementioned structure, the electricity generators 10 are consecutively aligned between the pressing plates 30. The connection rods 50 are inserted through the through-holes 33 of the pressing plates 30. Each fastening member 70 is screwed to the threaded portion 53 of a corresponding connection rod 50 so as to fasten the pressing plates 30, while supplying a specific pressure to the pressing plates 30. Then, the pressing plates 30 together compress the electricity generators 10 therebetween.

In this process, an operator or a torque device adjusts the fastening members 70 in accordance with a total length of the electricity generating assembly such that the pressing plates apply a pressure to the electricity generators 10 within a predetermined pressure range, that is, an optimal degree of compression for the electricity generators 10. However, due to differences in the skills of different operators or mechanical errors in torque devices, it is not easy to adjust the fastening pressure exerted by the fastening members 70 to within to the predetermined pressure range for the electricity generators 10.

Therefore, in the fuel cell stack 100 of the first embodiment, at least one spacer or stopper 90 is provided between the pressing plates 30. The spacer 90 controls the fastening pressure exerted by the fastening members 70 imposed on the pressing plates 30. Ultimately, the spacer 90 keeps the fastening pressure exerted by the fastening members 70 to be constant, thereby actually controlling the pressure exerted by the pressing plates 30.

In the first embodiment, the spacer 90 comprises a bar 91 passing through the electricity generators 10. The bar 91 passes through an edge portion of each electricity generator 10, and parallel to the axis along which the electricity generators 10 are arranged.

Openings 11a and 12a are formed at edge portions of the membrane-electrode assemblies 11 and the separators 12, respectively, positioned and dimensioned to receive the bar 91 therethrough. The holes 11a and 12a are formed at edge portions of the membrane-electrode assemblies 11 at an outer active region thereof, and at edge portions of the separators 12 at outer channels thereof.

The bar 91 comprises a conductive metallic material. An insulation layer 93 is formed at a surface of the bar 91 so as to prevent an electrical short circuit in the electricity generators 10. The insulation layer 93 comprises any suitable insulating material. The insulating material may be coated over the surface of the bar 91.

The bar 91 has a length selected to provide a predetermined pressure between the pressing plates 30 through the fastening members 70 to within the predetermined the pressure range for the electricity generators 10. In the illustrated embodiment, the bar 91 is secured to one of the pressing plates 30. That is, one end of the bar 91 is a fixed end that is secured to one of the pressing plates 30, while the other end of the bar 91 is a free end.

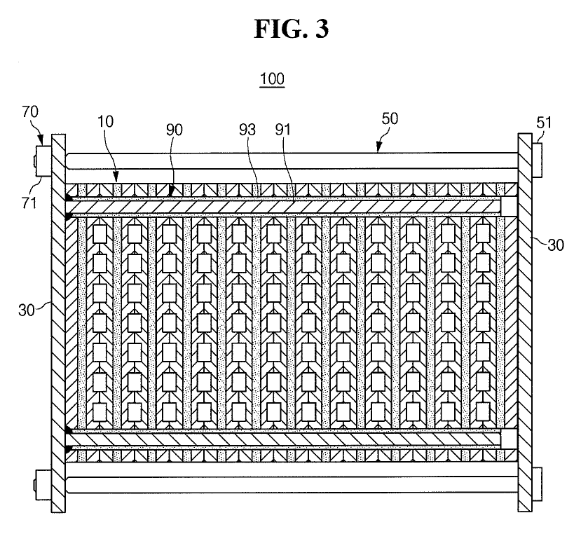

A process for assembling the fuel cell stack 100 of the first embodiment will now be described. First, as shown in FIG. 3, the electricity generators 10 are consecutively aligned between the pressing plates 30. The bar 91 passes through edge portions of the electricity generators 10, and thus is partially inserted therethrough. In this state, the electricity generators 10 are not pressed together. Since the bar 91 has a length selected to provide a pressure within a predetermined range for the electricity generators 10, its free end does not pass completely through at least the endmost electricity generator 10.

Thereafter, the connection rods 50 are inserted through the respective through-holes 33 of the pressing plates 30. The fastening members 70 are screwed onto the threaded portions 53 of the respective connection rods 50, thereby fastening the pressing plates 30 to each other therewith. The fastening members 70 urge the pressing plates 30 towards each other, thereby compressing the membrane-electrode assemblies 11 therebetween (FIG. 1).

In this process, since the bar 91 of the spacer 90 passes through the electricity generators 10 between the pressing plates 30, the electricity generators 10 are gradually compressed therebetween. Thus, the free end of the bar 91 contacts the pressing plate 30 to which it is not secured. Then, even when the fastening pressure exerted by the fastening members 70 is further increased, the pressing plates 30 will not further compress the electricity generators 10 because further movement of the pressing plates 30 is prevented by the bar 91 (FIG. 3).

According to the first embodiment, a spacer 90 controls the maximum fastening pressure exerted by the fastening members 70 to within predetermined pressure range for the electricity generators 10, irrespective of the skill of the operator or the mechanical error of the torque device. That is, the spacer 90 provides a uniform fastening pressure exerted by the fastening members 70 to within a predetermined pressure range for the electricity generators 10. Thus, the pressure exerted by the pressing plates 30 on the electricity generators 10 is controlled.

Therefore, an overall time for manufacturing the stack 100 can be shortened. Furthermore, manufacturing errors can be reduced. In particular, when the stack is repaired or refurbished, the electricity generators 10 can be easily disassembled and reassembled.

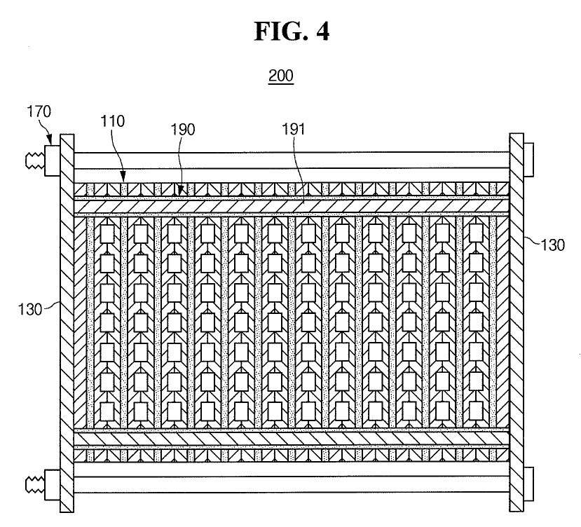

FIG. 4 is a cross-sectional view schematically illustrating a fuel cell stack 200 according to a second embodiment. Referring to FIG. 4, a fuel cell stack 200 of the second embodiment has the same general structure as the first embodiment except that a spacer 190 comprising a bar 191 is not secured to either pressing plate 130. The bar 191 passes through the electricity generators 110 disposed between the pressing plates 130. Both ends of the bar 191 are free ends that are not secured to either of the pressing plates 130.

In the second embodiment, when the fastening members 170 are tightened to compress the pressing plates 130, the electricity generators 110 are compressed thereby, and thus both ends of the bar 191 contact with the respective pressing plates 130. Thus, further motion of the pressing plates 130 is prevented by the ends of the bar 191, even if the fastening members 170 are further tightened. Accordingly, the pressing plates 130 do not further compress the electricity generators 110.

The structure and operation for the remaining the elements of the fuel cell stack 200 of the second embodiment are generally similar to those of the first embodiment. Thus, detailed descriptions thereof will be omitted.

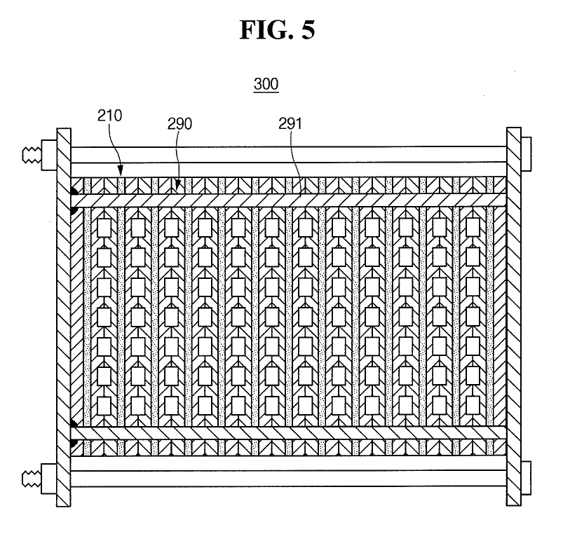

FIG. 5 is a cross-sectional view schematically illustrating a fuel cell stack 300 according to a third embodiment. Referring to FIG. 5, a fuel cell stack 300 of the third embodiment has a generally similar structure as the first embodiment, except for a spacer 290 comprising a non-conductive bar 291.

The bar 291 passes through electricity generators 210. In order to prevent an electrical short circuit in the electricity generators 210, the bar 291 comprises at least one of an insulating polymer or an insulating ceramic. In this case, a typical engineering plastic, for example, polyethylene (PE), may be used as the plastic material. In the third embodiment, since the bar 291 is made of a nonconductive insulating material, the insulation layer of the first embodiment is not required.

The structure and operation for the remaining elements of the fuel cell stack 300 of the third embodiment are generally similar to those of the first embodiment. Thus, detailed descriptions thereof will be omitted.

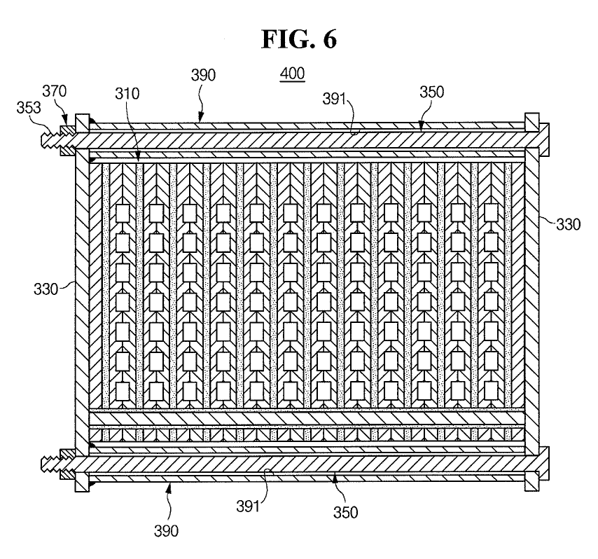

FIG. 6 is a cross-sectional view schematically illustrating a fuel cell stack 400 according to a fourth embodiment. Referring to FIG. 6, a fuel cell stack 400 of the fourth embodiment comprises a spacer 390 disposed between a pair of pressing plates 330, and through which a connection rod 350 is disposed.

In the fourth embodiment, the spacer 390 has a length selected to provide a predetermined pressure exerted by the pressing plates 330 on the electricity generators 310, within a predetermined a pressure range, that is, a fastening pressure exerted by the fastening members 370. The spacer 390 has a shape of a pipe or tube through which the connection rod 350 is inserted.

The spacer 390 comprises at least one of a metal, a plastic, and a ceramic. In the illustrated embodiment, the spacer 390 has a hollow portion 391 through which the connection rod 350 is inserted. The spacer 390 is secured to one of the pressing plates 330 in the illustrated embodiment. That is, a first end of the spacer 390 is a fixed end that is secured to one of the pressing plates 330, while a second end of the spacer 390 is a free end.

In this embodiment, a first end of the spacer 390 is secured to the pressing plate 330, so that a through-hole 33 (FIG. 1) in the pressing plate 330 through which the connection rod 350 is inserted is aligned with the hollow portion 391.

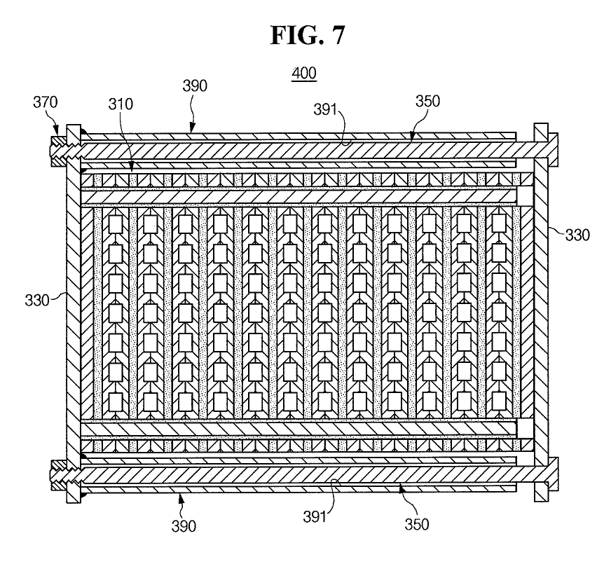

According to the fuel cell stack 400 of the fourth embodiment, the connection rod 350 is inserted into a respective through-hole 33 (FIG. 1) of a pressing plate 330 with the electricity generators 310 consecutively aligned between the pressing plates 330. In this process, the connection rod 350 is inserted through the hollow portion 391 of the spacer 390. As shown in FIG. 7, the electricity generators 310 are not initially compressed by the pressing plates 330. Thus, since the spacer 390 has a length selected to provide a pressure within a preselected pressure range for the electricity generators 310, a free end of the spacer 390 is spaced from the pressing plate 330 proximal to the free end.

Thereafter, each fastening member 370 is screwed onto a threaded portion 353 of the connection rod 350, thereby fastening the pressing plates 330 to each other by the connection rod 350 and the fastening member 370. The facing pressing plates 330 are moved towards each other as the fastening members 370 are tightened, thereby compressing the electricity generators 310 therebetween. In this process, the free end of the spacer 390 contacts the pressing plate 330 as the electricity generators 310 are gradually compressed between the pressing plates 330. Accordingly, the spacer 390 prevents further compression of the electricity generators 310, even if the fastening members 370 are further tightened because the end of the spacer 390 contacts the pressing plate 330, thereby preventing further movement of the pressing plate 330.

The remaining structure and operation of the fuel cell stack 400 of the fourth embodiment are generally similar those in the first embodiment. Thus, detailed descriptions thereof will be omitted.

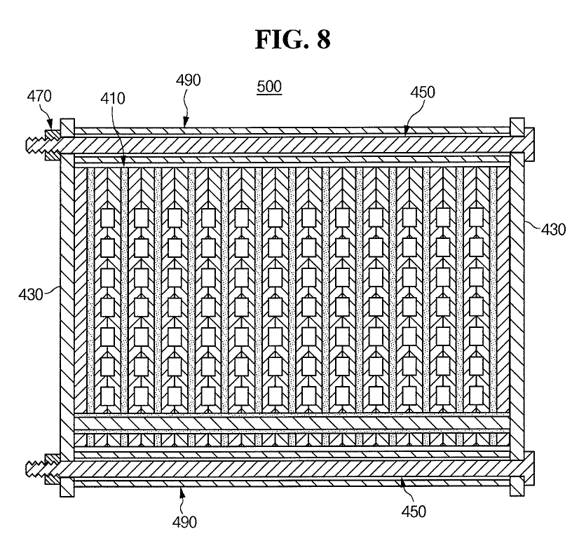

FIG. 8 is a cross-sectional view schematically illustrating a fuel cell stack 500 according to a fifth embodiment. Referring to FIG. 8, a fuel cell stack 500 of the fifth embodiment has a generally similar structure as the fourth embodiment. However, a spacer 490 is not secured to either pressing plate 430. A connection rod 450 is inserted into a hollow portion of the spacer 490 between the pressing plates 430. Both ends of the spacer 490 are free ends that are not secured to the pressing plates 430.

In the fifth embodiment, when a fastening member 470 is tightened to compress the pressing plates 430, electricity generators 410 are compressed so that the both ends of the spacer 490 respectively contact the pressing plates 430.

Thus with the pressing plates 430 contacting both ends of the spacer 490, even if the fastening members 470 are further tightened, to the pressing plates 430 do not further compress the electricity generators 410.

According to the aforementioned embodiments, a spacer controls a fastening pressure exerted by fastening members on pressing plates to within a predetermined pressure range. The desired pressure can be easily provided to the pressing plates irrespective of a difference in skill of an operator or a mechanical error of a torque device.

In addition, a problem can be solved that occurs when the fastening pressure exerted by the fastening members through the pressing plates is excessive or insufficient. Furthermore, not only is a time for manufacturing the stack reduced, but also manufacturing error. Furthermore, when the stack is repaired or reconditioned, the electricity generators can be easily disassembled and/or reassembled.

Although the exemplary embodiments and the modified examples have been described, the present invention is not limited to the embodiments and examples, but may be modified in various forms without departing from the scope of the appended claims, the detailed description, and the accompanying drawings. Therefore, such modifications are within the scope thereof.

What is claimed is:

1. A fuel cell stack for generating electricity, the fuel cell stack comprising:
a plurality of aligned electricity generators aligned with a first end and a second end;
a first pressing plate contacting the first end of the aligned electricity generators, and a second pressing plate contacting the second end of the aligned electricity generators;
fastening members configured and dimensioned to fasten the first and second pressing plates to each other and to compress the plurality of aligned electricity generators therebetween; and
a spacer disposed between the pressing plates to control a pressure exerted by the first and second pressing plates.

2. The fuel cell stack of claim 1, wherein the spacer comprises a bar passing through the plurality of electricity generators.

3. The fuel cell stack of claim 2, comprising a plurality of bars, wherein each of the plurality of bars passes through respective edge portions of the electricity generators.

4. The fuel cell stack of claim 2, wherein the bar is secured to one of the first and second pressing plates.

5. The fuel cell stack of claim 2, wherein the bar is not secured to either of the first or second pressing plates.

6. The fuel cell stack of claim 2, wherein a length of the bar is selected to provide a predetermined pressure range to the electricity generators according to a predetermined pressure exerted by the first and second pressing plates.

7. The fuel cell stack of claim 2, wherein the bar comprises a conductive metal and an insulation layer disposed on a surface thereof.

8. The fuel cell stack of clam 2, wherein the bar comprises an insulating plastic or ceramic material.

9. A fuel cell stack comprising:
an electricity generating assembly comprising unit-cell electricity generators;
a pair of pressing plates, one of each disposed on an end of the electricity generating assembly, configured and dimensioned to compress the electricity generators therebetween;
a plurality of connection rods extending between the pressing plates;
a plurality of fastening members, each secured to an end of a corresponding connection rod, thereby fastening the pressing plates to each other; and
a spacer disposed around each of the connection rods and between the pressing plates, dimensioned and configured to control a fastening pressure exerted by each fastening member.

10. The fuel cell stack of clam 9, wherein each spacer comprises a pipe or tube having a hollow portion through which a connection rod is inserted.

11. The fuel cell stack of claim 10, wherein the spacer is secured to one of the pressing plates.

12. The fuel cell stack of claim 11, wherein each pressing plate comprises a plurality of through-holes through which the connection rods pass, and the hollow portion of each spacer is aligned with one of the through-holes.

13. The fuel cell stack of claim 10, wherein the spacer is not secured to either of the pressing plates.

14. The fuel cell stack of claim 9, wherein the spacer has a length selected to provide a predetermined pressure range for the electricity generating assembly according to a predetermined fastening pressure exerted by the fastening members.

15. The fuel cell stack of claim 9, wherein the spacer comprises at least one of a metal, a plastic, and a ceramic.

16. The fuel cell stack of claim 9, wherein a bolt head is formed at a first end of each connection rod, and a threaded portion is formed at a second end of each connection rod.

17. The fuel cell stack of claim 16, wherein the fastening member comprises a nut dimensioned and configured to engage a threaded portion of the connection rod.

18. The fuel cell stack of claim 9, comprising a plurality of spacers, and the plurality of connection rods pass through respective edge portions of the pressing plates.
